(19) United States
(12) Patent Application Publication
(10) Pub. No.: US 2012/0096885 A1
(43) Pub. Date: Apr. 26, 2012

(54) SOLAR POWERED VEHICLE AIR-CONDITIONING SYSTEM

(75) Inventors: Shui Hung MAK, Hong Kong (HK); Ka Wai Eric Cheng, Hong Kong (HK)

(73) Assignee: Green Power Industrial Limited

(21) Appl. No.: 13/225,549

(22) Filed: Sep. 6, 2011

Related U.S. Application Data
(60) Provisional application No. 61/406,568, filed on Oct. 25, 2010.

(30) Foreign Application Priority Data
Nov. 26, 2010 (HK) 10111000.3

(51) Int. Cl. B60H 1/00; F25B 27/00

(52) U.S. Cl. 62/235.1; 165/42; 165/203

(57) ABSTRACT

A solar powered vehicle air-conditioning system for air conditioning a vehicle includes an air conditioning subsystem and a solar power subsystem. The air conditioning subsystem includes a compressor, a condenser, an evaporator and a plurality of valves and sensors, and is configured for air conditioning the vehicle. The solar power subsystem includes a solar photovoltaic module configured for generating electric power when being illuminated by sunlight, a battery module configured for providing electric power to the air conditioning subsystem, and a solar power control module configured for receiving the electric power from the solar photovoltaic module and charging the battery module thereby. The solar power control module is configured to regulate the charging current flowing from the solar power control module to the battery module to be equal to or less than a predetermined current value.

### CROSS REFERENCE TO RELATED PATENT APPLICATIONS

This patent application claims priority of Hong Kong short term application no. 10111000.3 filed on 26 Nov., 2010 and the benefit of U.S. provisional patent application No. 61/406,568 filed on Oct. 25, 2010, the entire contents of which are hereby incorporated by reference.

### FIELD OF THE PATENT APPLICATION

The present patent application generally relates to a solar powered air-conditioning system and more particularly to a solar-powered vehicle air-conditioning system suitable for being used for vehicles with existing alternators installed.

### BACKGROUND

The conventional air-conditioning system for a petrol vehicle is driven by the internal combustion engine (ICE). The dynamic control of the Vehicle Air-conditioning System (VAS) is usually not implemented because the speed control of the ICE to the VAS is not set up. Therefore the variable speed control for providing better efficiency of the VAS is not realized. The energy to drive the VAS is classically from the petrol which produces green-house gases.

The solar panel, also called photovoltaic panel, is now being used in many green products. One of the main application areas is being used for mobility. The electric vehicle is one of the major applications. It is also being used in static power source such as being installed in buildings or on the ground wherein the panel is configured to collect the solar power and convert the solar power to the electric power. The power can be used directly or stored in energy storage devices such as batteries or super-capacitors.

The power derived from the solar panel is highly dependent on the sun light intensity. There is also a maximum power point for a given sunlight.

### SUMMARY

The present patent application is directed to a solar powered vehicle air-conditioning system for air conditioning a vehicle. In one aspect, the system includes an air conditioning subsystem, the air conditioning subsystem including a compressor, a condenser, an evaporator and a plurality of valves and sensors, and being configured for air conditioning the vehicle; and a solar power subsystem, the solar power subsystem including a solar photovoltaic module configured for generating electric power when being illuminated by sunlight, a battery module configured for providing electric power to the air conditioning subsystem, and a solar power control module configured for receiving the electric power from the solar photovoltaic module and charging the battery module thereby. The solar power control module is configured to regulate the charging current flowing from the solar power control module to the battery module to be equal to or less than a predetermined current value. If the charging current flowing from the solar power control module to the battery module is less than the predetermined current value, the solar power control module is configured to allow an alternator of the vehicle to supply current to charge the battery module simultaneously. The solar power control module is configured to charge the battery module with a constant maximum voltage when the output voltage of the battery module is above a predetermined voltage threshold. The maximum voltage provided by the solar power control module is higher than the maximum output voltage provided by the alternator of the vehicle.

The solar power subsystem may further include a first diode module connected between the solar power control module and the battery module, and a second diode module connected between the alternator of the vehicle and the battery module, the first and the second diode modules being configured to limit the direction of the current flowing to the battery module.

The first diode module may include at least a first diode in forward biased connection between the solar power control module and the battery module, and the second diode module may include at least a second diode in forward biased connection between the alternator of the vehicle and the battery module.

The air conditioning subsystem may include a plurality of temperature sensors configured for sensing the temperature in the vehicle, and a control and indicator unit configured for controlling the compressor.

The solar power control module may be configured to regulate the charging current flowing from the solar power control module to the battery module through pulse width modulation.

The solar power control module may be configured to disable the solar photovoltaic module so that the battery module is charged solely by the current from the alternator of the vehicle.

The system may further include a current sensor installed at a side of the battery module and configured for sensing the current charging the battery module.

In another aspect, the solar powered vehicle air-conditioning system for air conditioning a vehicle includes an air conditioning subsystem, the air conditioning subsystem including a compressor, a condenser, an evaporator and a plurality of valves and sensors, and being configured for air conditioning the vehicle; and a solar power subsystem, the solar power subsystem including a solar photovoltaic module configured for generating electric power when being illuminated by sunlight, a battery module configured for providing electric power to the air conditioning subsystem, and a solar power control module configured for receiving the electric power from the solar photovoltaic module and charging the battery module thereby. The solar power control module is configured to regulate the charging current flowing from the solar power control module to the battery module to be equal to or less than a predetermined current value.

If the charging current flowing from the solar power control module to the battery module is less than the predetermined current value, the solar power control module may be configured to allow an alternator of the vehicle to supply current to charge the battery module simultaneously.

The solar power control module may be configured to charge the battery module with a constant maximum voltage when the output voltage of the battery module is above a predetermined voltage threshold.

The maximum voltage provided by the solar power control module may be higher than the maximum output voltage provided by the alternator of the vehicle.

The solar power subsystem may further include a first diode module connected between the solar power control module and the battery module, and a second diode module connected between the alternator of the vehicle and the battery module, the first and the second diode modules being configured to limit the direction of the current flowing to the battery module.

The first diode module may include at least a first diode in forward biased connection between the solar power control module and the battery module, and the second diode module may include at least a second diode in forward biased connection between the alternator of the vehicle and the battery module.

The air conditioning subsystem may include a plurality of temperature sensors configured for sensing the temperature in the vehicle, and a control and indicator unit configured for controlling the compressor.

The solar power control module may be configured to regulate the charging current flowing from the solar power control module to the battery module through pulse width modulation.

The solar power control module may be configured to disable the solar photovoltaic module so that the battery module is charged solely by the current from the alternator of the vehicle.

The system may further include a current sensor installed at a side of the battery module and configured for sensing the current charging the battery module.

In yet another aspect, the solar powered vehicle air-conditioning system for air conditioning a vehicle includes an air conditioning subsystem, the air conditioning subsystem including a compressor, a condenser, an evaporator and a plurality of valves and sensors, and being configured for air conditioning the vehicle; and a solar power subsystem, the solar power subsystem including a solar photovoltaic module configured for generating electric power when being illuminated by sunlight, a battery module configured for providing electric power to the air conditioning subsystem, and a solar power control module configured for receiving the electric power from the solar photovoltaic module and charging the battery module thereby. The solar power control module is configured to regulate the charging current flowing from the solar power control module to the battery module to be equal to or less than a predetermined current value. If the charging current flowing from the solar power control module to the battery module is less than the predetermined current value, the solar power control module is configured to allow an alternator of the vehicle to supply current to charge the battery module simultaneously.

The solar power control module may be configured to charge the battery module with a constant maximum voltage when the output voltage of the battery module is above a predetermined voltage threshold; and the maximum voltage provided by the solar power control module may be higher than the maximum output voltage provided by the alternator of the vehicle.

The solar power subsystem may further include a first diode module connected between the solar power control module and the battery module, and a second diode module connected between the alternator of the vehicle and the battery module, the first and the second diode modules being configured to limit the direction of the current flowing to the battery module, the first diode module including at least a first diode in forward biased connection between the solar power control module and the battery module, the second diode module including at least a second diode in forward biased connection between the alternator of the vehicle and the battery module.

### BRIEF DESCRIPTIONS OF THE DRAWINGS

FIG. 1 is a schematic diagram of a solar powered vehicle air-conditioning system according to an embodiment of the present patent application.

FIG. 2 is a schematic diagram of an air-conditioning subsystem of the solar powered vehicle air-conditioning system depicted in FIG. 1.

FIG. 3 is a schematic diagram of a solar power subsystem of the solar powered vehicle air-conditioning system depicted in FIG. 1.

FIG. 4 illustrates the solar powered vehicle air-conditioning system depicted in FIG. 1 in a non-solar powered mode.

### DETAILED DESCRIPTION

Reference will now be made in detail to a preferred embodiment of the solar-powered vehicle air-conditioning system disclosed in the present patent application, examples of which are also provided in the following description. Exemplary embodiments of the solar-powered vehicle air-conditioning system disclosed in the present patent application are described in detail, although it will be apparent to those skilled in the relevant art that some features that are not particularly important to an understanding of the solar-powered vehicle air-conditioning system may not be shown for the sake of clarity.

Furthermore, it should be understood that the solar-powered vehicle air-conditioning system disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

The following embodiments of the present patent application provide an air-conditioning system installed in a vehicle. The air-conditioning system derives power from the solar cell and the electric power is used to drive the electric motor with compressor to produce the cooling. The solar cell is also installed with maximum power point tracking (MPPT) for the battery charger. The system provides a new method of solar driven system together with the existing alternator installed in a vehicle. A method is also provided by the embodiments to work with the existing system based on retrofitting and without deteriorating the overall performance and affecting other components.

The embodiments provide a solar power driven vehicle air-conditioning (VAC) system. The VAC is an electric motor driven compressor. The system has an energy storage unit to store the power from the solar panel. The solar is the main energy input. If the energy is not sufficient, the energy from the alternator of the vehicle is used to charge the battery. The battery power is connected to a motor drive to drive the motor, which is connected to a compressor, for the air-conditioning. The control system is working in parallel with the alternator to supply power to the batteries. It does not influence the operation of the alternator. It only monitors the total current to the batteries and ensures it is not over the safety limit. In all cases, the maximum current to the battery is monitored and its maximum voltage to the battery is also monitored. Any over-limit voltage or current will cause the control to reduce the power flow and even stop the operation.

A scheme is introduced to a solar charging system and is to provide power to a vehicle air-conditioning system (VAS). The VAS is working with a compressor driven by an electric motor. The compressor and electric motor can be separated units or integrated units. The solar charging system has limited power from solar illumination. A maximum power point tracking is installed to optimize the power output. When solar power received is higher than the power consumption to the compressor or when the compressor is off, the energy will be stored in the battery of other energy storage devices. The battery is connected to electric driver, which is in turn connected to the compressor. The battery is powered by both solar power and the alternator. The alternator is connected to the internal combustion engine to provide the rotational power. The solar power control system (SPCS) is configured to be connected with the solar photovoltaic modules and convert their power to the battery bank. The SPCS is implemented with maximum power point tracking (MPPT). The output of the SPCS is cascaded with power diode which is connected in series in the form of bridge diode or simply series diode connection. The output of the SPCS with diode is connected directly and electrically to the battery bank. The voltage control from the input side of SPCS and the output side of SPCS or the output current of SPCS does not require any current or voltage feedback from the alternator. The output current of SPCS and the output current of alternator are added together and supplied to the battery bank. No electrical control signal is made between the SPCS to the alternator. When the battery current limit is reached, SPCS will reduce its current output by PWM control. When the battery voltage limit is reached, SPCS will reduce its voltage output by PWM control. The power diode or diode is not limited to a semi-conductor diode, while controlled relays and semiconductor transistors can also be used instead.

### The System Operation

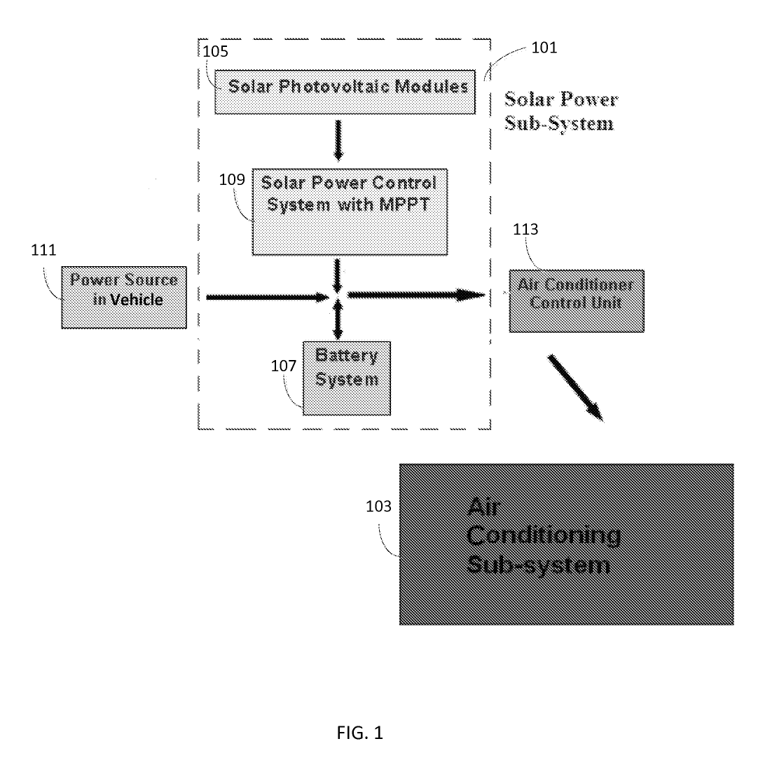

FIG. 1 is a schematic diagram of a solar powered vehicle air-conditioning system according to an embodiment of the present patent application. Referring to FIG. 1, the overall system includes a solar power subsystem 101 and an air-conditioning subsystem 103. The electrical power obtained from the solar panel 105 is used to charge the battery 107. The circuit is implemented by a control system 109 with MPPT (maximum power point tracking) and is able to obtain the maximum power from the solar panel using voltage and/or current mode control.

The battery system 107 is configured to store electric energy from the solar panel. The power supplied to the battery system 107 is also tapped from the power source 111 of the vehicle. It is usually from the alternator or the generator of the vehicle. If the solar power MPPT converter system 109 outputs to the battery system 107 at Vₚₘ₁ (in a 24V battery system, the voltage can be set at 28.3V, but not limited to 28.3V), Vₚₘ₁ is slightly higher than the alternator voltage of the vehicle. The alternator voltage of the vehicle is controlled to be around a controllable voltage Vₐ that is used to charge the battery system 107 effectively (in a 24V system, the alternator output voltage varies from 26 to 28V with a maximum of 28V).

Referring to FIG. 1, the battery system 107 is configured to provide power to an air-conditioner control unit 113. The control unit 113 is configured to provide electric power to the air-conditioner subsystem 103. The air-conditioning subsystem 103 is configured to convert the electric power into the cooling effect to the vehicle compartment.

### The Air-conditioning Subsystem

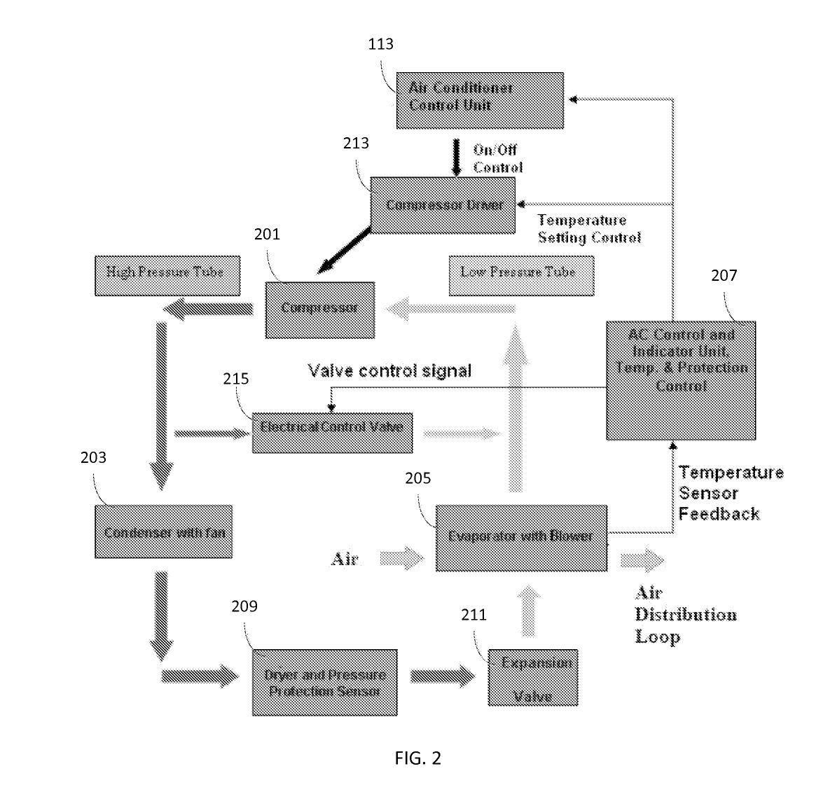

FIG. 2 is a schematic diagram of the air-conditioning subsystem of the solar powered vehicle air-conditioning system depicted in FIG. 1. Referring to FIG. 2, the main components of the subsystem include a compressor 201, a condenser 203, an evaporator 205 and a plurality of valves and sensors. The compressor 201 is a mechanical system which requires a motor related actuator to provide the compression means. The compressor 201 can be discretely connected with a motor or alternatively an integrated unit may be constructed including both the compressor 201 and the motor.

The air conditioner control unit 113 is configured to excite the compressor 201 with a suitable electrical control, which is usually a variable frequency control.

The AC control and indicator block 207 is configured to receive the signals to control the compressor 201 and the AC control unit 113. The compressor 201 provides high pressure to the refrigerant that, for example, rises from a couple of bars to over 10 bars. The refrigerant will then go through the condenser 203 to reduce the temperature through a force cooling fans.

A dryer and pressure protection sensor 209 is configured to provide filtering and safety for the pressure in the refrigerant before it goes through an expansion valve 211. Once the refrigerant is expanded, according to the physical gas law:

$$\frac{PV}{T} = constant ,$$

where P is the pressure, V is the volume and T is the temperature. The refrigerant's temperature is then reduced significantly. The refrigerant is then passed through the evaporator with a blower 205 to have temperature exchange. An air-distribution loop is also shown in FIG. 2 to illustrate how the cool air is generated. The cool air is then obtained from the blower. The blower is also called the fans coil.

There is an air-distribution loop flow through the fans coil. A temperature exchange happens and the incoming air is exchanged, gets its temperature reduced, and comes out from the evaporator 205.

The temperature regulation can be controlled by the air-flow of the air-distribution loop through an electric fan unit or through the pressure compression action of the compressor 203, which is also driven electrically by a compressor drive 213.

The temperature sensors are installed in locations for temperature sensing and control. A typical location is the vehicle compartment or the outlet of the air-conditioning unit.

When the machine starts, the difference in the pressure between the input and output sides of the compressor 201 will increase the compressor's power demand. A large current will be driven. The control system here is firstly to close the electrical control valve 215 for a short period of time (for example, around 50 seconds, but not limited to that) and then the pressure at the two sides of the compressor will be close to each other. The compressor driver 213 will then excite the compressor 201 to produce the compression. There is usually a speed ramping of the compressor driver 213 to increase its speed from zero to the final speed during a period of time (which is usually 0-1 minute). This procedure will reduce the power demand from the electrical system and ensure a good start up profile.

### Solar Power Subsystem

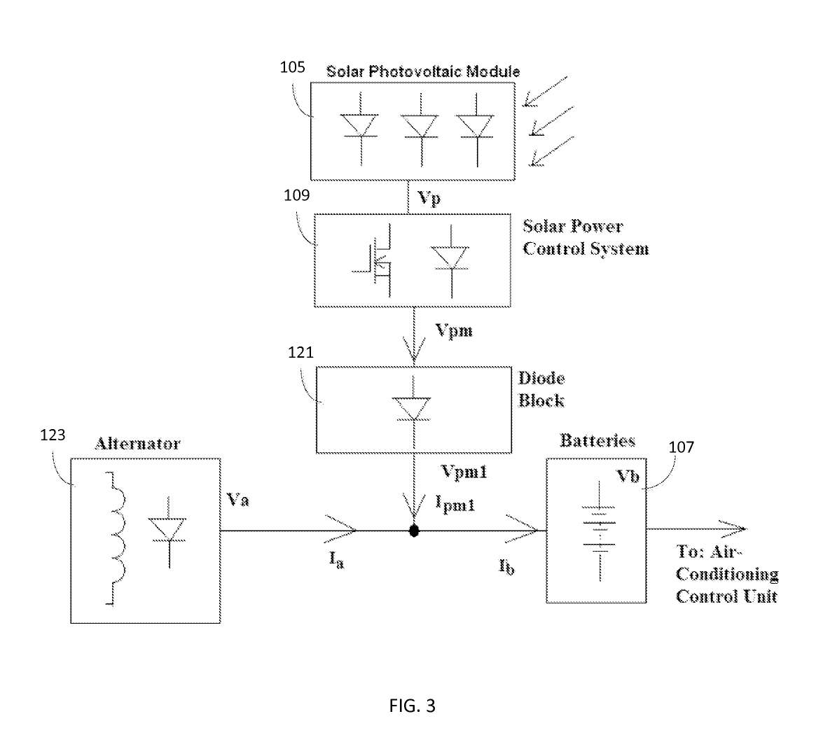

FIG. 3 is a schematic diagram of a solar power subsystem of the solar powered vehicle air-conditioning system depicted in FIG. 1. The power derived from the solar panel varies extensively with solar illumination. Its output voltage Vₚ also varies with a large range. Referring to FIG. 1 and FIG. 3, an MPPT Solar Power Control System 109 is used to provide a maximum power derived from the Solar Photovoltaic Module (SPM) 105. Vₚ is therefore controlled to be such an optimal voltage Vₚₒ. Vₚₘ is the output voltage from the Solar Power Control System (SPCS) 109 which has the MPPT installed. It is then passed through a diode block 121 which allows unit directional current flow from the SPCS 109 to the batteries 107 (the battery bank). The SPCS 109 has an internal voltage and current control. Its primary function is the MPPT, which is to provide a constant voltage coming from the SPM 105.

When the SPM 105 is under solar illumination, the SPCS 109 is configured to control a current flowing to the batteries. The current setting is called I_{cm}, which is the recommended current for the battery charging or the design. The SPCS 109 is configured to control its input voltage at Vₚₒ, which regulates the current flowing to the batteries to be I_{cm} or below. I_{cm} is also considered as a current limit for protection.

When the batteries are close to being fully charged, the output voltage of the batteries rises to above a predetermined voltage threshold and the charging circuit is to be set at a maximum voltage Vₚₘₚ allowed in the SPCS 109 for constant voltage mode of charging.

High power SPM operation:

As Vₚₘ₁ and Vₐ are electrically connected, both the SPCS 109 and the alternator 123 of the vehicle supply current to the batteries. Under high power available from the SPM 105, the internal diode of the alternator 123 will prevent the current from flowing from the alternator 123 to batteries 107. In this case, Vₐ has a set point for maximum voltage output Vₐₘ. The design of the voltage control is the following.

Vₚₘ₁ is slightly higher than Vₐₘ, the maximum voltage from the alternator 123 of the vehicle. The voltage difference is:

V_{d}=Vₚₘ₁Vₐₘ

Vₐₘ is electrically connected with Vₚₘ₁ through a forward biased diode. Vₚₘ and Vₚₘ₁ are different from each other by the forward biased diode voltage drop when the diode block is forward biased and the difference is equal to an undefined voltage when the diode block is reversely biased. V_{d} is set at a small voltage (around 0.3V but not limited to that), which is a fraction of 1 V.

### Low Power SPM Operation:

If the design of the SPM 105 is less than the maximum power to charge the batteries 107 under constant current mode charging, the charging current to the batteries will usually be less than I_{cm}. The SPCM 109 is configured to control its state to be on or off depending on the I_{cm}. If the measured current to the battery is larger than I_{cm}, the SPCS 109 will reduce its power flow through the pulse width modulation (PWM) control of the SPCS 109. In most cases, if the measured current is less than I_{cm}, the SPCS 109 continues to supply current to the batteries 107 and simultaneously allows the alternator 123 to supply current to the batteries 107.

The alternator is installed in the vehicle all the time. The SPCS 109 is not configured to control its operation. The principle here is to add the SPCS 109 with the existing alternator 123 and thereby to provide power to the batteries.

### Current Flow Control

The output current of the alternator 123 is Iₐ. The output current of the SPCS 109 is Iₚₘ₁. The charging current to the batteries 107 is I_{b}. According to the electric node law:

I_{b}=Iₚₘ₁+Iₐ

The SPCS 109 is configured to only control the I_{b}. A current sensor is installed at a side of the batteries 107 and provides a current reference as a control parameter to charge the batteries 107. The PWM action of the SPCS 109 is only configured to regulate the V_{PM1}. Therefore there is no control action from the SPCS 109 to the alternator 123. This arrangement is to ensure that the retrofitting is simple and there is no need to understand the existing vehicle alternator design.

### Non-Solar Mode Air-Conditioning Operation

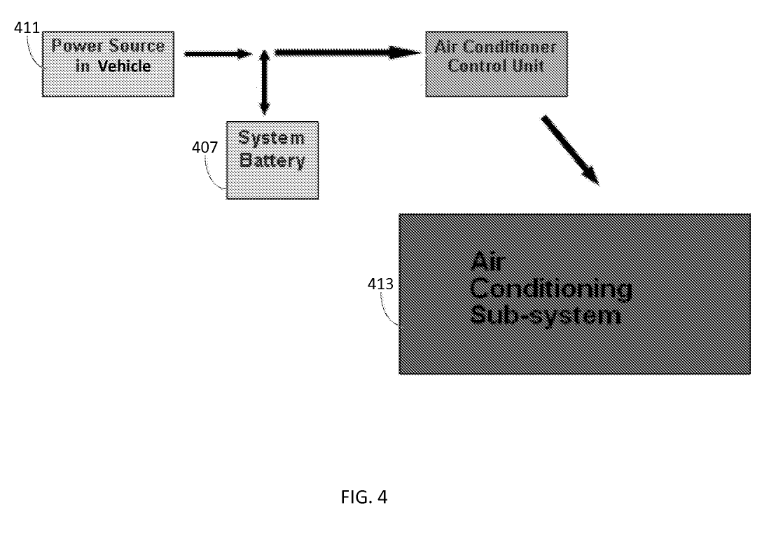

FIG. 4 illustrates the solar powered vehicle air-conditioning system depicted in FIG. 1 in a non-solar powered mode. Referring to FIG. 4, when the solar-power source is disabled by the solar power control system (not shown in FIG. 4), the power is derived from the batteries 407 to drive the compressor in the air conditioning subsystem 413. This may happen when there is no sun light or the solar panel is not installed. In this case, the power is derived from the alternator 411 of the vehicle only. In this case the system can be further reduced.

In the above embodiments, the system works with the battery cell, and is not limited to the number of battery cells and not affected by the power level of each component including the photovoltaic, the alternator and the air-conditioning compressor.

While the present patent application has been shown and described with particular references to a number of embodiments thereof, it should be noted that various other changes or modifications may be made without departing from the scope of the present invention.

What is claimed is:

1. A solar powered vehicle air-conditioning system for air conditioning a vehicle, the system comprising:
an air conditioning subsystem, the air conditioning subsystem comprising a compressor, a condenser, an evaporator and a plurality of valves and sensors, and being configured for air conditioning the vehicle; and
a solar power subsystem, the solar power subsystem comprising a solar photovoltaic module configured for generating electric power when being illuminated by sunlight, a battery module configured for providing electric power to the air conditioning subsystem, and a solar power control module configured for receiving the electric power from the solar photovoltaic module and charging the battery module thereby; wherein:
the solar power control module is configured to regulate the charging current flowing from the solar power control module to the battery module to be equal to or less than a predetermined current value;
if the charging current flowing from the solar power control module to the battery module is less than the predetermined current value, the solar power control module is configured to allow an alternator of the vehicle to supply current to charge the battery module simultaneously;
the solar power control module is configured to charge the battery module with a constant maximum voltage when the output voltage of the battery module is above a predetermined voltage threshold; and
the maximum voltage provided by the solar power control module is higher than the maximum output voltage provided by the alternator of the vehicle.

2. The system of claim 1, wherein the solar power subsystem further comprises a first diode module connected between the solar power control module and the battery module, and a second diode module connected between the alternator of the vehicle and the battery module, the first and the second diode modules being configured to limit the direction of the current flowing to the battery module.

3. The system of claim 2, wherein the first diode module comprises at least a first diode in forward biased connection between the solar power control module and the battery module, and the second diode module comprises at least a second diode in forward biased connection between the alternator of the vehicle and the battery module.

4. The system of claim 1, wherein the air conditioning subsystem comprises a plurality of temperature sensors configured for sensing the temperature in the vehicle, and a control and indicator unit configured for controlling the compressor.

5. The system of claim 1, wherein the solar power control module is configured to regulate the charging current flowing from the solar power control module to the battery module through pulse width modulation.

6. The system of claim 1, wherein the solar power control module is configured to disable the solar photovoltaic module so that the battery module is charged solely by the current from the alternator of the vehicle.

7. The system of claim 1 further comprising a current sensor installed at a side of the battery module and configured for sensing the current charging the battery module.

8. A solar powered vehicle air-conditioning system for air conditioning a vehicle, the system comprising:
an air conditioning subsystem, the air conditioning subsystem comprising a compressor, a condenser, an evaporator and a plurality of valves and sensors, and being configured for air conditioning the vehicle; and
a solar power subsystem, the solar power subsystem comprising a solar photovoltaic module configured for generating electric power when being illuminated by sunlight, a battery module configured for providing electric power to the air conditioning subsystem, and a solar power control module configured for receiving the electric power from the solar photovoltaic module and charging the battery module thereby; wherein:
the solar power control module is configured to regulate the charging current flowing from the solar power control module to the battery module to be equal to or less than a predetermined current value.

9. The system of claim 8, wherein if the charging current flowing from the solar power control module to the battery module is less than the predetermined current value, the solar power control module is configured to allow an alternator of the vehicle to supply current to charge the battery module simultaneously.

10. The system of claim 8, wherein the solar power control module is configured to charge the battery module with a constant maximum voltage when the output voltage of the battery module is above a predetermined voltage threshold.

11. The system of claim 8, wherein the maximum voltage provided by the solar power control module is higher than the maximum output voltage provided by the alternator of the vehicle.

12. The system of claim 8, wherein the solar power subsystem further comprises a first diode module connected between the solar power control module and the battery module, and a second diode module connected between the alternator of the vehicle and the battery module, the first and the second diode modules being configured to limit the direction of the current flowing to the battery module.

13. The system of claim 12, wherein the first diode module comprises at least a first diode in forward biased connection between the solar power control module and the battery module, and the second diode module comprises at least a second diode in forward biased connection between the alternator of the vehicle and the battery module.

14. The system of claim 8, wherein the air conditioning subsystem comprises a plurality of temperature sensors configured for sensing the temperature in the vehicle, and a control and indicator unit configured for controlling the compressor.

15. The system of claim 8, wherein the solar power control module is configured to regulate the charging current flowing from the solar power control module to the battery module through pulse width modulation.

16. The system of claim 8, wherein the solar power control module is configured to disable the solar photovoltaic module so that the battery module is charged solely by the current from the alternator of the vehicle.

17. The system of claim 8 further comprising a current sensor installed at a side of the battery module and configured for sensing the current charging the battery module.

18. A solar powered vehicle air-conditioning system for air conditioning a vehicle, the system comprising:
an air conditioning subsystem, the air conditioning subsystem comprising a compressor, a condenser, an evaporator and a plurality of valves and sensors, and being configured for air conditioning the vehicle; and
a solar power subsystem, the solar power subsystem comprising a solar photovoltaic module configured for generating electric power when being illuminated by sunlight, a battery module configured for providing electric power to the air conditioning subsystem, and a solar power control module configured for receiving the electric power from the solar photovoltaic module and charging the battery module thereby; wherein:
the solar power control module is configured to regulate the charging current flowing from the solar power control module to the battery module to be equal to or less than a predetermined current value; and if the charging current flowing from the solar power control module to the battery module is less than the predetermined current value, the solar power control module is configured to allow an alternator of the vehicle to supply current to charge the battery module simultaneously.

19. The system of 18, wherein the solar power control module is configured to charge the battery module with a constant maximum voltage when the output voltage of the battery module is above a predetermined voltage threshold; and the maximum voltage provided by the solar power control module is higher than the maximum output voltage provided by the alternator of the vehicle.

20. The system of claim 18, wherein the solar power subsystem further comprises a first diode module connected between the solar power control module and the battery module, and a second diode module connected between the alternator of the vehicle and the battery module, the first and the second diode modules being configured to limit the direction of the current flowing to the battery module, the first diode module comprising at least a first diode in forward biased connection between the solar power control module and the battery module, the second diode module comprising at least a second diode in forward biased connection between the alternator of the vehicle and the battery module.
